(19) United States
(12) Patent Application Publication
(10) Pub. No.: US 2011/0089909 A1
(43) Pub. Date: Apr. 21, 2011

(54) ELECTRIC ENERGY STORAGE MODULE CONTROL DEVICE

(75) Inventors: Yoji HIGASHI, Chiba-shi (JP); Kunihiro MITSUYA, Chiba-shi (JP); Hiroshi NISHIZAWA, Nagano-shi (JP)

(73) Assignee: NISSHINBO HOLDINGS INC., TOKYO (JP)

(21) Appl. No.: 12/896,312

(22) Filed: Oct. 1, 2010

(30) Foreign Application Priority Data
Oct. 19, 2009 (JP) 2009-240746

(51) Int. Cl. H02J 7/00

(52) U.S. Cl. 320/166

(57) ABSTRACT

Provided is an electric energy storage module control device for controlling an electric energy storage module (2) including a plurality of capacitors (20) connected in series, the electric energy storage module control device including a voltage control circuit (10) connected in parallel to each of the plurality of capacitors (20), in which the voltage control circuit (10) includes a constant voltage control part (14) for controlling and preventing a voltage across the constant voltage control part from exceeding a predetermined voltage, and a resistor (12) connected in series to the constant voltage control part (14), and the predetermined voltage is lower than an upper limit applied voltage of each of the plurality of capacitors (20).

### BACKGROUND OF THE INVENTION

1. Field of the Invention

The present invention relates to an electric energy storage module control device for controlling a voltage of an electric energy storage module including a plurality of capacitors connected in series.

2. Description of the Related Art

There is known an electric energy storage module in which a plurality of capacitors, such as electric double layer capacitors, are connected in series. When such an electric energy storage module is charged for use as a power supply source, there may be variations in voltages applied to the capacitors because of individual differences among the capacitors, including capacitance differences, or a temperature difference at the time of use. This situation causes a problem that a specific capacitor may have a short life.

As one of the countermeasures against the above-mentioned problem, there has been proposed a voltage limiting circuit for, if the capacitor has been charged to a voltage exceeding its upper limit voltage, discharging the capacitor so as to reduce the voltage thereof to the upper limit voltage. Such a voltage limiting circuit includes, for example, a Zener diode or a shunt regulator, and is connected in parallel to each capacitor (see, for example, FIGS. 5(b) and 5(c) of Japanese Patent No. 3244592, and Japanese Patent Application Laid-open Nos. Hei 06-261452 and 2005-101434). According to this method, each capacitor is prevented from being over-charged, to thereby delay the progress of degradation of the capacitor.

Alternatively, aimed at absorbing the variations in capacitor voltages, a voltage control circuit for providing voltage equalization has been proposed. Specifically, for example, FIG. 5(a) of Japanese Patent No. 3244592 illustrates a voltage control circuit which is formed of resistors having the same resistance and connected in parallel to each capacitor. Owing to a current flowing through those resistors, a voltage of the whole electric energy storage module is equally divided among the capacitors.

### SUMMARY OF THE INVENTION

Among the above-mentioned conventional technologies, in the method of limiting the voltage of each capacitor so as not to exceed its upper limit voltage, such voltage control is not performed while the voltage of the capacitor is equal to or lower than the upper limit voltage, even if there are variations in voltages of the capacitors. This means that there may be variations in life among the capacitors. Further, if the capacitor has been charged to a voltage exceeding its upper limit voltage, it is necessary to cause a high current to flow through the voltage limiting circuit so as to quickly consume the charged energy. It is therefore necessary to prepare such a large-scale circuit or a heat dissipation mechanism as to withstand heat generation due to the high current.

On the other hand, according to the method in which the resistor is connected in parallel to each capacitor, the capacitor voltages may be controlled to be equalized all the time, regardless of the magnitude of the voltage of the whole electric energy storage module. In such an equalization circuit, however, a current flows continuously via the resistors all the time, leading to wasted power consumption, which causes a problem that the capacitor may suffer large voltage drop while the electric energy storage module is not in use. Conversely, if the resistance of the resistor is increased to suppress such power consumption, the ability to equalize the capacitor voltages lowers.

The present invention has been made in view of the above-mentioned circumstances, and one of the objects thereof is to provide an electric energy storage module control device having low power consumption, which is capable of equalizing capacitor voltages even while the capacitor voltages are equal to or lower than upper limit voltages thereof.

In order to solve the above-mentioned problems, the present invention provides an electric energy storage module control device for controlling an electric energy storage module including a plurality of capacitors connected in series, the electric energy storage module control device including a voltage control circuit connected in parallel to each of the plurality of capacitors, in which: the voltage control circuit includes: a constant voltage control part for controlling and preventing a voltage across the constant voltage control part from exceeding a predetermined voltage; and a resistor connected in series to the constant voltage control part; and the predetermined voltage is lower than an upper limit applied voltage of each of the plurality of capacitors.

Further, in the above-mentioned electric energy storage module control device, the constant voltage control part may include a shunt regulator.

Still further, in the above-mentioned electric energy storage module control device, the shunt regulator may include a cathode terminal, an anode terminal, and a reference voltage terminal, and the reference voltage terminal may be directly connected to the cathode terminal.

Yet further, in the above-mentioned electric energy storage module control device, the predetermined voltage may be between 50% or more and 85% or less with respect to the upper limit applied voltage of each of the plurality of capacitors.

Yet further, in the above-mentioned electric energy storage module control device, the resistor may have a resistance of between 2Ω or larger and 50Ω or smaller. Further, the resistor may have a resistance of between 5Ω or larger and 10Ω or smaller.

### BRIEF DESCRIPTION OF THE DRAWINGS

In the accompanying drawings:

FIG. 1 is a diagram illustrating a circuit configuration of an electric energy storage module control device according to a first embodiment of the present invention;

FIG. 2 is a graph illustrating an example of a temporal change in a voltage of each capacitor;

FIG. 3 is a graph illustrating an example of a relationship between a resistance and current consumption and a relationship between the resistance and a voltage difference among the capacitors at the time of convergence;

FIG. 4 is a diagram illustrating a circuit configuration of an electric energy storage module control device according to a second embodiment of the present invention; and

FIG. 5 is a graph illustrating a temporal change in a voltage of each capacitor according to an example of the present invention.

### DETAILED DESCRIPTION OF THE INVENTION

Now, embodiments of the present invention are described below with reference to the accompanying drawings.

### First Embodiment

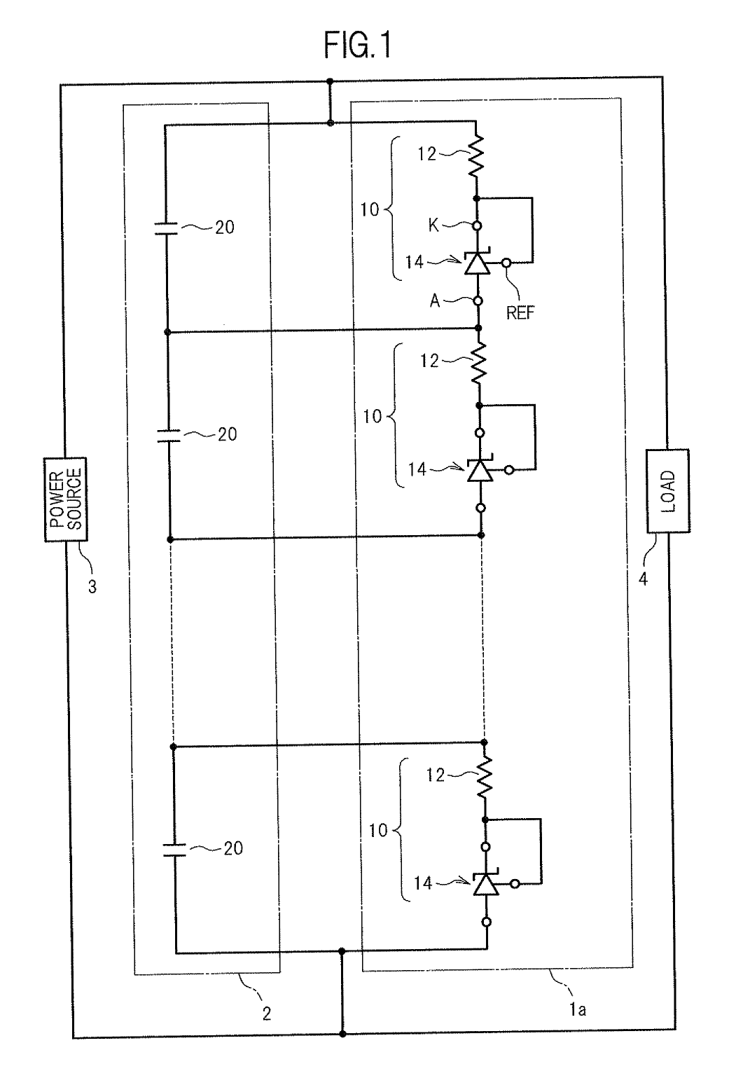

FIG. 1 is a diagram illustrating a circuit configuration of an electric energy storage module control device 1a according to a first embodiment of the present invention. An electric energy storage module 2 to be controlled by the electric energy storage module control device 1a according to this embodiment includes a plurality of capacitors 20 connected in series to one another. It should be noted that in this embodiment, N capacitors 20 are connected in series. Each of the capacitors 20 is an electric energy storage device, such as an electric double layer capacitor, which is capable of storing power when supplied with a current. The N capacitors 20 are of the same type and the same capacitance. To charge the electric energy storage module 2, a voltage is applied across both end terminals thereof from an external power source 3. Power is storaged in the electric energy storage module 2 and utilized for driving a load 4.

As illustrated in FIG. 1, the electric energy storage module control device 1a includes the same number of (N) voltage control circuits 10 as the capacitors 20 forming the electric energy storage module 2. The voltage control circuits 10 are connected in parallel to the capacitors 20 on a one-on-one basis.

Each of the voltage control circuits 10 includes a resistor 12 and a constant voltage control part 14 connected in series to the resistor 12. N resistors 12 have the same resistance (hereinafter, referred to as resistance R).

The constant voltage control part 14 controls a voltage across the constant voltage control part 14 so as not to exceed a predetermined voltage. Hereinafter, the predetermined voltage is referred to as an operating voltage Vₛ of the constant voltage control part 14. If a voltage of the capacitor 20 (hereinafter, referred to as capacitor voltage V_{c}) becomes the operating voltage Vₛ or higher, the voltage of the constant voltage control part 14 included in the voltage control circuit 10 connected in parallel to the capacitor 20 is maintained not to exceed the operating voltage Vₛ. Then, a voltage (V_{c}−Vₛ) corresponding to a difference between the capacitor voltage V_{c} and the operating voltage Vₛ of the constant voltage control part 14 is applied across the resistor 12 connected in series to the constant voltage control part 14. It should be noted that N constant voltage control parts 14 have the same operating voltage Vₛ.

In this embodiment, the constant voltage control part 14 does not allow a current to flow unless the voltage applied thereacross becomes the operating voltage Vₛ or higher. Accordingly, while the capacitor voltage V_{c} is lower than the operating voltage Vₛ, no current flows through the voltage control circuit 10 connected in parallel to the capacitor 20.

The constant voltage control part 14 includes a shunt regulator. As illustrated in FIG. 1, the shunt regulator includes both end terminals (cathode terminal K and anode terminal A) and a reference voltage terminal REF (reference terminal), as connection terminals to the outside. The shunt regulator has a built-in reference voltage (hereinafter, referred to as internal reference voltage V_{ref}), and operates so that the reference voltage terminal REF has a voltage equal to the internal reference voltage V_{ref}.

In this embodiment, the cathode terminal K of the shunt regulator is connected to one end of the resistor 12, and the anode terminal A thereof is connected to one end of the capacitor 20. Another end of the resistor 12 is connected to another end of the capacitor 20. Further, in this embodiment, the reference voltage terminal REF of the shunt regulator is directly connected to the cathode terminal K. With this configuration, feedback control is made on the current flowing through the shunt regulator so that the cathode terminal K has a voltage equal to the internal reference voltage V_{ref} of the shunt regulator. In other words, in this embodiment, the operating voltage Vₛ of the constant voltage control part 14 is equal to the internal reference voltage V_{ref} of the shunt regulator.

Now, an operation of the electric energy storage module control device 1a will be described.

Using the power source 3, the electric energy storage module 2 is charged until the voltage across the electric energy storage module 2 reaches a voltage Vₘ, which is N·Vₛ or higher. Then, when the capacitor voltage V_{c} of the capacitor 20 becomes the operating voltage Vₛ or higher, a current starts to flow through the shunt regulator included in the corresponding voltage control circuit 10. At this time, the voltage across the constant voltage control part 14 is maintained at the operating voltage Vₛ which is constant regardless of fluctuations in the capacitor voltage V_{c}. Then, a voltage (Vₘ−N·Vₛ) corresponding to a difference between the voltage Vₘ of the whole electric energy storage module 2 and the total value N·Vₛ of the voltages generated across the N constant voltage control parts 14 is divided by the N resistors 12. Here, the resistors 12 have the same resistance R, and hence the voltage (Vₘ−N·Vₛ) is equally divided by the resistors 12. In other words, the resistors 12 have the same voltage Vᵣ generated thereacross. Also, because the constant voltage control parts 14 have the same operating voltage Vₛ, the voltage control circuits 10 have the same voltage generated thereacross. This way, the capacitor voltages V_{c} of the capacitors 20 are equalized. The capacitor voltage V_{c} in this case is expressed as follows.

V_{c}=Vₛ+Vᵣ=Vₘ/N

It should be noted that such equalization control on the capacitor voltages V_{c} is carried out by the electric energy storage module control device 1a in the case of discharging the electric energy storage module 2 to the load 4, as well as in the case of charging the electric energy storage module 2.

The capacitor voltage V_{c} is divided by the resistor 12 and the constant voltage control part 14 within the voltage control circuit 10, and hence the voltage Vᵣ generated by the resistor 12 is the voltage (V_{c}−Vₛ), which is lower than the capacitor voltage V_{c}. Therefore, according to the electric energy storage module control device 1a of this embodiment, a small current flows through the resistor 12 compared with a case where the same voltage as the capacitor voltage V_{c} is applied across the resistor 12. In addition, because the voltage (V_{c}−Vₛ) generated by the resistor 12 is low compared with the capacitor voltage V_{C}, even if there are variations in resistances R among the resistors 12, an equalization error due to the variations may be suppressed compared with a case of directly equalizing the capacitor voltages V_{c}.

Further, as described above, when the capacitor voltage V_{c} becomes lower than the operating voltage Vₛ, the current stops flowing through the voltage control circuit 10. Accordingly, even if a current flows through the voltage control circuit 10 to discharge the capacitor 20 when the electric energy storage module 2 is not in use, the discharge via the voltage control circuit 10 may stop at a time when the capacitor voltage V_{c} reduces to the operating voltage Vₛ. Therefore, further power consumption of the voltage control circuit 10 is prevented, to thereby suppress voltage drop of the capacitor 20 due to the voltage control circuit 10.

Next, preferred values of the operating voltage Vₛ of the constant voltage control part 14 and the resistance R of the resistor 12 will be described.

The operating voltage Vₛ of each constant voltage control part 14 is desired to have a value of 50% or more and 85% or less with respect to an upper limit voltage Vₘₐₓ of the capacitor 20. Here, the upper limit voltage Vₘₐₓ of the capacitor 20 is a voltage of the capacitor 20 which is determined when the electric energy storage module 2 has been fully charged under a normal usage environment, that is, a maximum allowable applied voltage of the capacitor 20. During the charge of the electric energy storage module 2, power is supplied from the power source 3, with the voltage V_{c} of each capacitor 20 prevented from exceeding the upper limit voltage Vₘₐₓ. The upper limit voltage Vₘₐₓ may be set to a rated voltage value specified by a manufacturer of the capacitor 20. The rated voltage may be defined by a value which is determined according to JIS D 1401:2009 at an environmental temperature of 60° C. to 80° C.

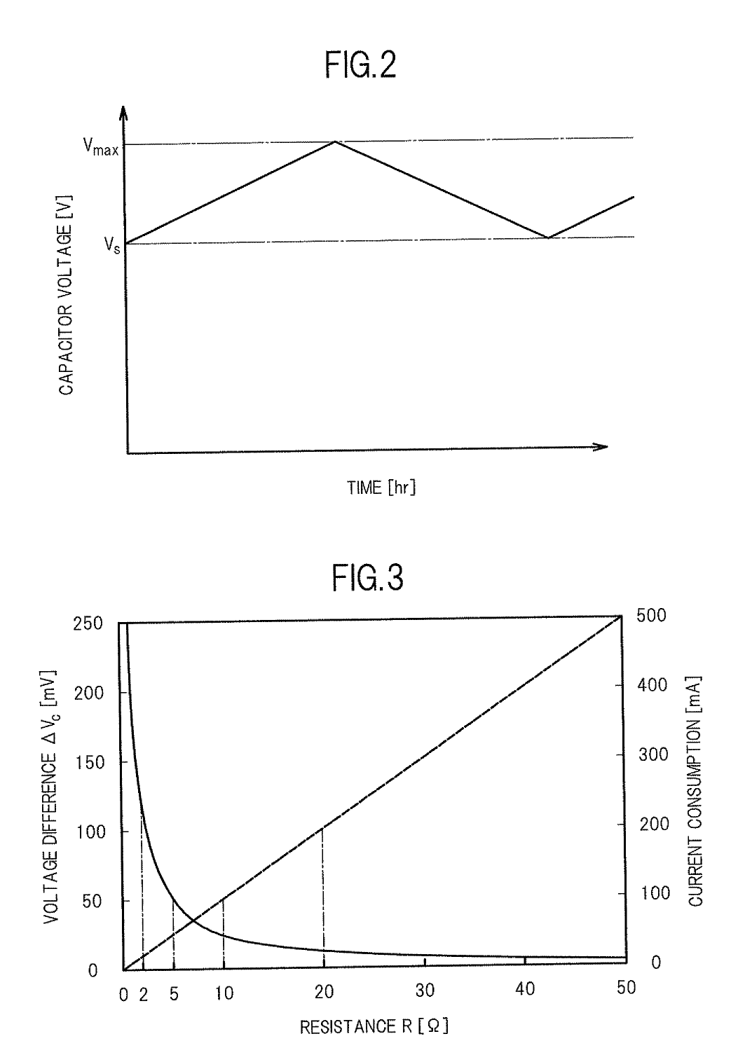

The capacitor voltages V_{c} of the capacitors 20 are equalized only while each capacitor voltage V_{c} exceeds the operating voltage Vₛ, and hence the charge/discharge of the electric energy storage module 2 is performed when the capacitor voltage V_{c} falls within a range between the operating voltage Vₛ and the upper limit voltage Vₘₐₓ, inclusively. FIG. 2 is a graph illustrating an example of a temporal change in the capacitor voltage V_{c}, which is caused by such charge/discharge. Here, if the operating voltage V_{c} is set too low with respect to the upper limit voltage Vₘₐₓ, the voltage Vᵣ applied across the resistor 12 becomes large when the capacitor 20 is almost fully charged, resulting in an increase in consumption current flowing through the resistor 12. For that reason, the operating voltage Vₛ is desired to be 50% or more of the upper limit voltage Vₘₐₓ of the capacitor 20.

On the other hand, if the operating voltage Vₛ of the constant voltage control part 14 is set too high, output energy of the capacitor 20 reduces in the case where the capacitor 20 is discharged from the fully-charged state (state in which the capacitor voltage V_{c} is equal to the upper limit voltage Vₘₐₓ) until the capacitor voltage V_{c} becomes equal to the operating voltage Vₛ. For that reason, the operating voltage Vₛ is desired to be 85% or less of the upper limit voltage Vₘₐₓ of the capacitor 20. If the operating voltage Vₛ falls within the range between 50% or more and 85% or less with respect to the upper limit voltage Vₘₐₓ, by the time when the capacitor voltage V_{c} reduces to the operating voltage Vₛ, each capacitor 20 may output energy within a range from about 75% to about 28% with respect to energy of the capacitor 20 storaged by the time of full charge. It should be noted that in a case of a normal battery, considering the influence on the life etc., charge/discharge is performed with energy within a range of about 30% with respect to the storaged energy at the time of full charge.

Further, the resistance R of each resistor 12 is preferably 2Ω or larger and 50Ω or smaller, more preferably 2Ω or larger and 20Ω or smaller, still more preferably 5Ω or larger and 10Ω or smaller.

As the resistance R becomes smaller, the current flowing through the resistor 12 becomes larger, resulting in wasted current consumption. Therefore, from the viewpoint of suppressing the current consumption due to the resistor 12, the resistance R needs to be large to some extent. Specifically, the voltage Vᵣ generated across the resistor 12 when the electric energy storage module 2 is fully charged is equal to a difference (Vₘₐₓ−Vₛ) between the upper limit voltage Vₘₐₓ of the capacitor 20 and the operating voltage Vₛ of the constant voltage control part 14. If the voltage Vᵣ is 0.5 V or higher and 1.5 V or lower and the resistance R is 2Ω or larger and 50Ω or smaller, the current flowing through each resistor 12 falls within a range between about 10 mA and 750 mA, which prevents the current consumption from exceeding 750 mA at most. For that reason, the resistance R is preferably 2Ω or larger, more preferably 5Ω or larger. It should be noted that in a case where priority is placed on suppressing the current consumption, the resistance R may be 10Ω or larger.

On the other hand, as the resistance R becomes larger, the equalizing ability of the electric energy storage module control device 1a on the capacitor voltages V_{c} becomes lowered. Specific description thereof is given below.

Capacitors 20 have variations in amount of leakage current due to variations in electrostatic capacitance and temperature during their use. The variations in leakage current are mainly responsible for the variations in capacitor voltages V_{c} among the capacitors 20. According to this embodiment, the variations in leakage current are compensated with the current flowing through the resistors 12. Specifically, assuming that a maximum leakage current difference among the capacitors 20 is represented by ΔI_{L}, the electric energy storage module control device 1a operates so that a voltage difference ΔV_{c} in capacitor voltage V_{c} generated among the capacitors 20 converges within a value expressed as follows.

ΔV_{c}=ΔI_{L}·R

As is apparent from the expression, the voltage difference ΔV_{c} is proportional to the resistance R. Therefore, as the resistance R becomes smaller, the capacitor voltages V_{c} may converge to the same value with more accuracy. In other words, as the resistance R becomes smaller, the equalizing ability of the electric energy storage module control device 1a increases more. For that reason, in the case of control on the electric energy storage module 2 including normal capacitors, the resistance R is preferably 50Ω or smaller, more preferably 20Ω or smaller. It should be noted that in a case where priority is placed on equalizing the capacitor voltages V_{C}, the resistance R may be 10Ω or smaller.

For the reasons described above, the resistance R is set to 2Ω or larger and 50Ω or smaller, more preferably 2Ω or larger and 20Ω or smaller. In those ranges, the resistance R may be set to 2Ω or larger and 10Ω or smaller for use with priority given to the equalization of the capacitor voltages V_{C}, while the resistance R may be set to 10Ω or larger and 20Ω or smaller for use with priority given to the suppression in current consumption. Further, in a case where the requirements of both the increase in equalizing ability and the suppression in current consumption need to be satisfied in a balanced manner, the resistance R is preferably set to 5Ω or larger and 10Ω or smaller.

FIG. 3 is a graph illustrating a relationship between the resistance R and the current consumption, and a relationship between the resistance R and the voltage difference ΔV_{c} among the capacitors 20 at the time of convergence. In FIG. 3, the solid line indicates the relationship between the resistance R and the current consumption, and the broken line indicates the relationship between the resistance R and the voltage difference ΔV_{c}. In the graph, the horizontal axis represents the resistance R (Ω), and the left-hand vertical axis represents the voltage difference ΔV_{c} (mV) while the right-hand vertical axis represents the current consumption (mA). It should be noted that in the graph, the leakage current difference ΔI_{L} among the capacitors 20 is assumed to be 5 mA. Further, the voltage Vᵣ (=Vₘₐₓ−Vₛ) generated across the resistor 12 when the electric energy storage module 2 is fully charged is assumed to be 0.5 V.

As illustrated in FIG. 3, as the resistance R becomes smaller, the current consumption becomes larger inversely. On the other hand, in proportion to the resistance R, the voltage difference ΔV_{c} increases. Further, centering around the position of an intersection between the solid line and the broken line, in the range of the resistance R between 5Ω or larger and 10Ω or smaller, the voltage difference ΔV_{c} takes 50 mV or smaller and the current consumption takes 100 mA or smaller, leading to the understanding that the requirements of both the increase in equalizing ability and the suppression in current consumption are satisfied.

According to the electric energy storage module control device 1a of this embodiment described above, within the range in which the capacitor voltage V_{c} of the capacitor 20 is equal to or higher than the operating voltage Vₛ of the constant voltage control part 14, the capacitor voltages V_{c} of the capacitors 20 may be controlled to be substantially equal to one another. Further, compared with the case where only the resistor 12 is connected in parallel to each capacitor 20, the current consumption of the voltage control circuit 10 may be suppressed to be low. Also, as long as the capacitor voltage V_{c} is equal to or lower than the operating voltage Vₛ, the current consumption of the voltage control circuit 10 may be reduced to 0.

Still further, according to the electric energy storage module control device 1a of this embodiment, the resistor 12 limits the current flowing through the voltage control circuit 10, and hence the breakage of the circuit elements clue to overcharge of the capacitor 20 may be prevented.

### Second Embodiment

Next, an electric energy storage module control device 1b according to a second embodiment of the present invention will be described. It should be noted that the description of the electric energy storage module control device 1b according to this embodiment is mainly directed to a difference from the first embodiment, omitting the same configuration and function as the electric energy storage module control device 1a according to the first embodiment. The same components as the first embodiment are denoted by the same reference symbols.

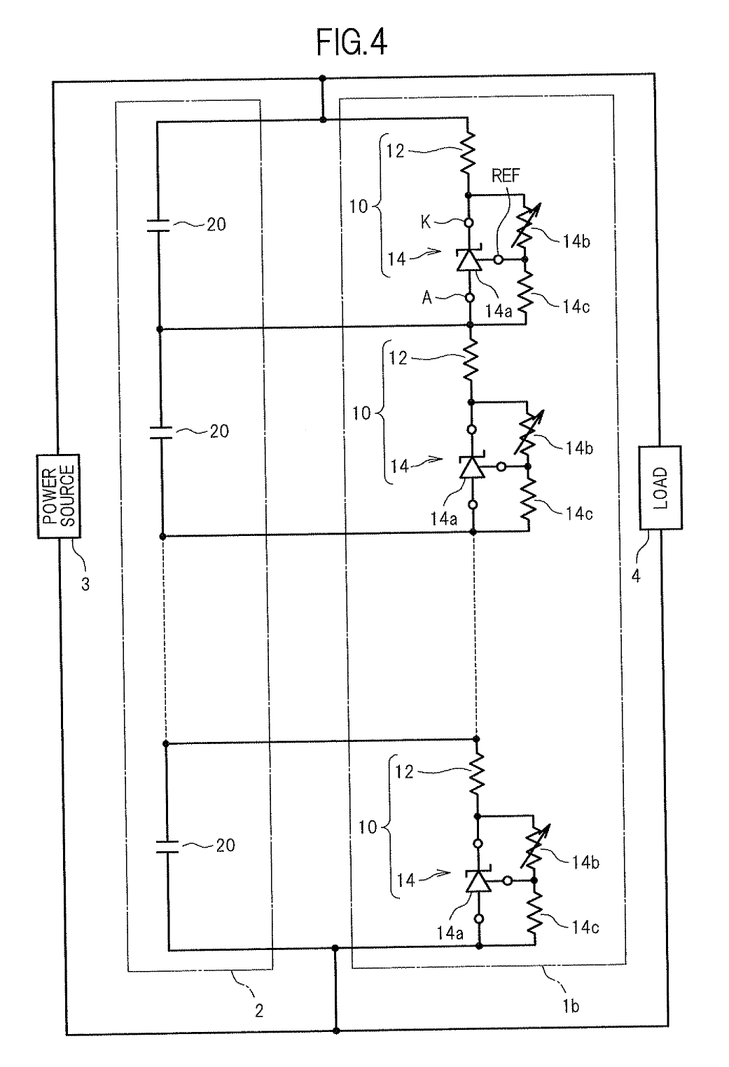

FIG. 4 is a circuit diagram illustrating a circuit configuration of the electric energy storage module control device 1b according to this embodiment. Similarly to the first embodiment, what is to be controlled by the electric energy storage module control device 1b according to this embodiment is the electric energy storage module 2 including the capacitors 20 connected in series to one another. Further, similarly to the first embodiment, the voltage control circuits 10 are connected in parallel to the capacitors 20, respectively, and each include the resistor 12 and the constant voltage control part 14 connected in series to each other.

In this embodiment, unlike the first embodiment, the constant voltage control part 14 includes, in addition to a shunt regulator 14a, two resistors 14b and 14c connected in series to each other. One terminal of the resistor 14b is connected to a cathode terminal K of the shunt regulator 14a, and another terminal thereof is connected to one terminal of the resistor 14c and a reference voltage terminal REF of the shunt regulator 14a. Another terminal of the resistor 14c is connected to an anode terminal A of the shunt regulator 14a.

In this case, if the amount of current flowing through the reference voltage terminal REF is sufficiently small, the operating voltage Vₛ of the whole constant voltage control part 14 takes an approximate value expressed by the following expression.

Vₛ=(1R1/R2)·V_{ref}

where R1 represents a resistance of the resistor 14b, R2 represents a resistance of the resistor 14c, and V_{ref} represents an internal reference voltage of the shunt regulator 14a. From the above expression, according to this embodiment, the constant voltage control part 14 operates with the operating voltage Vₛ, which is determined in accordance with the resistances R1 and R2. In other words, the voltage across the constant voltage control part 14 is controlled so as not to exceed the operating voltage Vₛ. As described above, according to the electric energy storage module control device 1b of this embodiment, the constant voltage control part 14 is allowed to operate with the operating voltage Vₛ which is different from the internal reference voltage V_{ref} built in the shunt regulator 14a.

At least one of the resistors 14b and 14c employs a variable resistor to adjust its resistance, to thereby appropriately adjust the operating voltage Vₛ of the constant voltage control part 14 with no modification to the circuit configuration. FIG. 4 illustrates the case where the resistor 14b is a variable resistor.

It should be noted that the embodiments of the present invention are not limited to what has been described above. For example, the constant voltage control part 14 may have a different circuit configuration from those of the first and second embodiments. Further, the capacitor 20 included in the electric energy storage module 2 and connected in parallel to the corresponding voltage control circuit 10 may be a capacitor module in which a plurality of capacitor cells are connected to each other.

### EXAMPLE

Now, as an example of the present invention, a specific example of the electric energy storage module control device to which the present invention is applied is described below. The present invention is, however, not limited to the following example.

According to this example, in the circuit configuration illustrated in FIG. 1, as the capacitors 20, five electric double layer capacitors, manufactured by Nisshinbo Holdings Inc., having a capacitance of 250 F and a rated voltage of 3.0 V were connected in series to form the electric energy storage module 2. Further, in the circuit configuration illustrated in FIG. 1, as the resistor 12, “CR1/4-100FV”, manufactured by Hokuriku Electric Industry Co., Ltd, having a resistance of 10Ω and a rated power of ¼ W was used, and as the shunt regulator forming the constant voltage control part 14, “HA17431FPAJ-E1-E”, manufactured by Renesas Technology Corp., having an internal reference voltage of 2.495 V was used, to thereby form the electric energy storage module control device 1a. It should be noted that in the circuit configuration illustrated in FIG. 1, a ceramic capacitor for stable operation of the shunt regulator may be connected in parallel between the anode terminal and the cathode terminal or the reference voltage terminal of each shunt regulator forming the constant voltage control part 14.

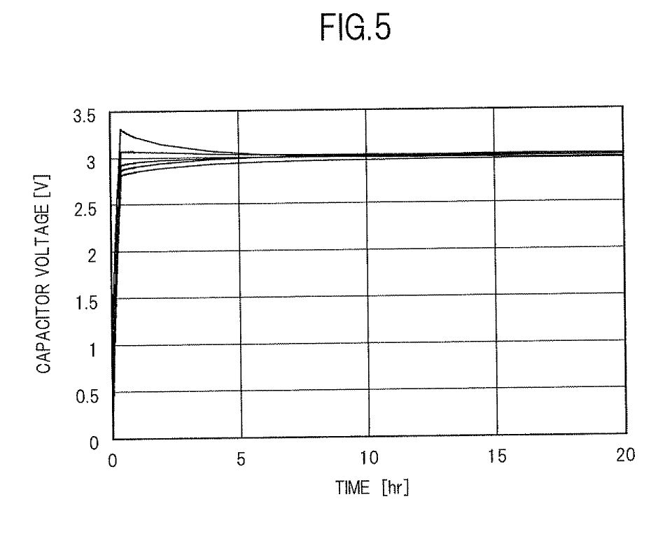

FIG. 5 illustrates temporal changes in voltages of the capacitors 20 obtained when the electric energy storage module control device 1a was used to charge the electric energy storage module 2, starting from the state where the five capacitors 20 are completely discharged. As illustrated in FIG. 5, it was found that, immediately after the start of charge of the capacitors 20, there are variations in capacitor voltages of the capacitors 20, but as time elapses, the voltage of each capacitor 20 converges to about 3 V, with the result that the voltages of the capacitors 20 are equalized.

While there have been described what are at present considered to be certain embodiments of the invention, it will be understood that various modifications may be made thereto, and it is intended that the appended claims coverall such modifications as fall within the true spirit and scope of the invention.

What is claimed is:

1. An electric energy storage module control device for controlling an electric energy storage module comprising a plurality of capacitors connected in series,
the electric energy storage module control device comprising a voltage control circuit connected in parallel to each of the plurality of capacitors,
wherein the voltage control circuit comprises:
a constant voltage control part for controlling and preventing a voltage across the constant voltage control part from exceeding a predetermined voltage; and
a resistor connected in series to the constant voltage control part, and
wherein the predetermined voltage is lower than an upper limit applied voltage of each of the plurality of capacitors.

2. The electric energy storage module control device according to claim 1, wherein the constant voltage control part comprises a shunt regulator.

3. The electric energy storage module control device according to claim 2,
wherein the shunt regulator comprises a cathode terminal, an anode terminal, and a reference voltage terminal, and
wherein the reference voltage terminal is directly connected to the cathode terminal.

4. The electric energy storage module control device according to claim 1, wherein the predetermined voltage is 50% or more and 85% or less with respect to the upper limit applied voltage of each of the plurality of capacitors.

5. The electric energy storage module control device according to claim 1, wherein the resistor has a resistance of 2Ω or larger and 50Ω or smaller.

6. The electric energy storage module control device according to claim 5, wherein the resistor has a resistance of 5Ω or larger and 10Ω or smaller.
